(19) United States
(12) Patent Application Publication
(10) Pub. No.: US 2018/0063013 A1
(43) Pub. Date: Mar. 1, 2018

(54) SYSTEMS AND METHODS FOR NETWORK CONNECTION BUFFER SIZING

(71) Applicant: Machine Zone, Inc., East Palo Alto, CA (US)

(72) Inventor: Lev Walkin, Santa Clara, CA (US)

(21) Appl. No.: 15/245,718

(22) Filed: Aug. 24, 2016

(51) Int. Cl. H04L 12/873

(52) U.S. Cl. CPC H04L 47/522; H04L 67/42

(57) ABSTRACT

Implementations of the present disclosure are directed to a method, a system, and a computer program storage device for determining and implementing transmission buffer sizes for network connections. A computer-implemented method includes: obtaining a respective bandwidth requirement for each of a plurality of network connections between at least one server and at least one client device; determining a respective latency for each network connection; calculating a desired transmission buffer size for each network connection based on the respective bandwidth requirement and the respective latency for the network connection; setting a new transmission buffer size for each network connection to the desired transmission buffer size for the network connection; and transmitting data from the at least one server to the at least one client device using the new transmission buffer sizes.

### BACKGROUND

This specification relates to systems and methods for sizing transmission buffers for a plurality of network connections.

In general, connections between client devices and a server system utilize transmission buffers to transmit data. Transmission control protocol (TCP), for example, may use a send buffer and a receive buffer in the operating system kernel of each connected device. Improper sizing of such transmission buffers can lead to various issues, including latency problems and/or memory pressure. When transmission buffers are too small, for example, excessive handshaking between a server and a client device may cause latency issues and/or prevent the connection from keeping up with desired data transfer rates. Likewise, when transmission buffers are too large, memory requirements for maintaining the buffers can become excessive, particularly for client-server systems involving thousands or millions of connections. There is a need for systems and methods that facilitate the proper sizing of transmission buffers for connections between server systems and clients.

### SUMMARY

Examples of the systems and methods described herein are used to size transmission buffers for a plurality of network connections. A round-trip time (RTT) or latency is measured for each connection using, for example, an operating system kernel on a server and an application that extracts the RTT from the kernel. A bandwidth requirement is determined for each connection based on, for example, required data transfer rates associated with one or more applications running on the connected devices. In a specific example, transmission buffer sizes are determined based on the RTT and the bandwidth requirement, and may be updated or adjusted periodically, to account for changes in connectivity.

The systems and methods described herein are particularly advantageous for real-time systems having thousands or millions of connections. The systems and methods are able to optimize transmission buffer sizes to minimize latency and reduce memory pressure. Such buffer size adjustments may be made dynamically (e.g., on the fly and/or over time) and are preferably specific to each connection, with buffer sizes being optimized for each connection individually (e.g., based on a bandwidth requirement and an RTT for the connection). By keeping memory usage to a minimum, the number of connections that can be handled by the system and the bandwidth of those connections are maximized.

In general, one aspect of the subject matter of this specification relates to a computer-implemented method that includes: obtaining a respective bandwidth requirement for each of a plurality of network connections between at least one server and at least one client device; determining a respective latency for each network connection; calculating a desired transmission buffer size for each network connection based on the respective bandwidth requirement and the respective latency for the network connection; setting a new transmission buffer size for each network connection to the desired transmission buffer size for the network connection; and transmitting data from the at least one server to the at least one client device using the new transmission buffer size.

In certain examples, obtaining the respective bandwidth requirement for each of the plurality of network connections includes determining a target data transfer rate for an application running on a client device associated with one of the network connections. Obtaining the respective bandwidth requirement for each of the plurality of network connections can include, for example, measuring an amount of data transmitted over at least one network connection during a time period. In some instances, determining the respective latency for each network connection includes determining a round-trip time for at least one network connection. The respective latency for the at least one network connection can be or include, for example, the round-trip time divided by two.

In various implementations, determining the round-trip time includes obtaining the round-trip time from the at least one server. Calculating the desired transmission buffer size for each network connection can include determining a product of the respective bandwidth requirement and the respective latency for at least one network connection (e.g., a TCP/IP connection or a connectionless connection). In some examples, the method includes: determining a respective latency for at least one network connection at a later time; and calculating a new desired transmission buffer size for the at least one network connection based on the respective latency at the later time.

In another aspect, the subject matter of this specification relates to a system that includes one or more computers programmed to perform operations including: obtaining a respective bandwidth requirement for each of a plurality of network connections between at least one server and at least one client device; determining a respective latency for each network connection; calculating a desired transmission buffer size for each network connection based on the respective bandwidth requirement and the respective latency for the network connection; setting a new transmission buffer size for each network connection to the desired transmission buffer size for the network connection; and transmitting data from the at least one server to the at least one client device using the new transmission buffer size.

In certain examples, obtaining the respective bandwidth requirement for each of the plurality of network connections includes determining a target data transfer rate for an application running on a client device associated with one of the network connections. Obtaining the respective bandwidth requirement for each of the plurality of network connections can include, for example, measuring an amount of data transmitted over at least one network connection during a time period. In some instances, determining the respective latency for each network connection includes determining a round-trip time for at least one network connection. The respective latency for the at least one network connection can be or include, for example, the round-trip time divided by two.

In various implementations, determining the round-trip time includes obtaining the round-trip time from the at least one server. Calculating the desired transmission buffer size for each network connection can include, for example, determining a product of the respective bandwidth requirement and the respective latency for at least one network connection (e.g., a TCP/IP connection or a connectionless connection). In some examples, the operations include: determining a respective latency for at least one network connection at a later time; and calculating a new desired transmission buffer size for the at least one network connection based on the respective latency at the later time.

In another aspect, the subject matter of this specification relates to a non-transitory computer-readable medium having instruction stored thereon that, when executed by one or more computers, cause the computers to perform operations including: obtaining a respective bandwidth requirement for each of a plurality of network connections between at least one server and at least one client device; determining a respective latency for each network connection; calculating a desired transmission buffer size for each network connection based on the respective bandwidth requirement and the respective latency for the network connection; setting a new transmission buffer size for each network connection to the desired transmission buffer size for the network connection; and transmitting data from the at least one server to the at least one client device using the new transmission buffer size.

Elements of embodiments or examples described with respect to a given aspect of the invention can be used in various embodiments or examples of another aspect of the invention. For example, it is contemplated that features of dependent claims depending from one independent claim can be used in apparatus, systems, and/or methods of any of the other independent claims.

The details of one or more embodiments of the subject matter described in this specification are set forth in the accompanying drawings and the description below. Other features, aspects, and advantages of the subject matter will become apparent from the description, the drawings, and the claims.

### DESCRIPTION OF THE DRAWINGS

FIG. 1 is a schematic diagram of an example system for determining and adjusting transmission buffer sizes for a plurality of network connections.

FIG. 2 is a schematic diagram of an example system for determining and adjusting transmission buffer sizes for a connection between a server system and a client device.

FIG. 3 is a schematic data flow diagram for a connection between a server system and a client device.

FIG. 4 is an example method for adjusting transmission buffer sizes for a plurality of network connections.

### DETAILED DESCRIPTION

In general, the systems and methods described herein are used to size transmission buffers for sending messages over network connections (e.g., TCP/IP or User Datagram Protocol/IP connections) between one or more servers and a plurality of client devices. A goal of the systems and methods is to size transmission buffers such that memory usage and latency are minimized, while achieving a desired bandwidth for each connection.

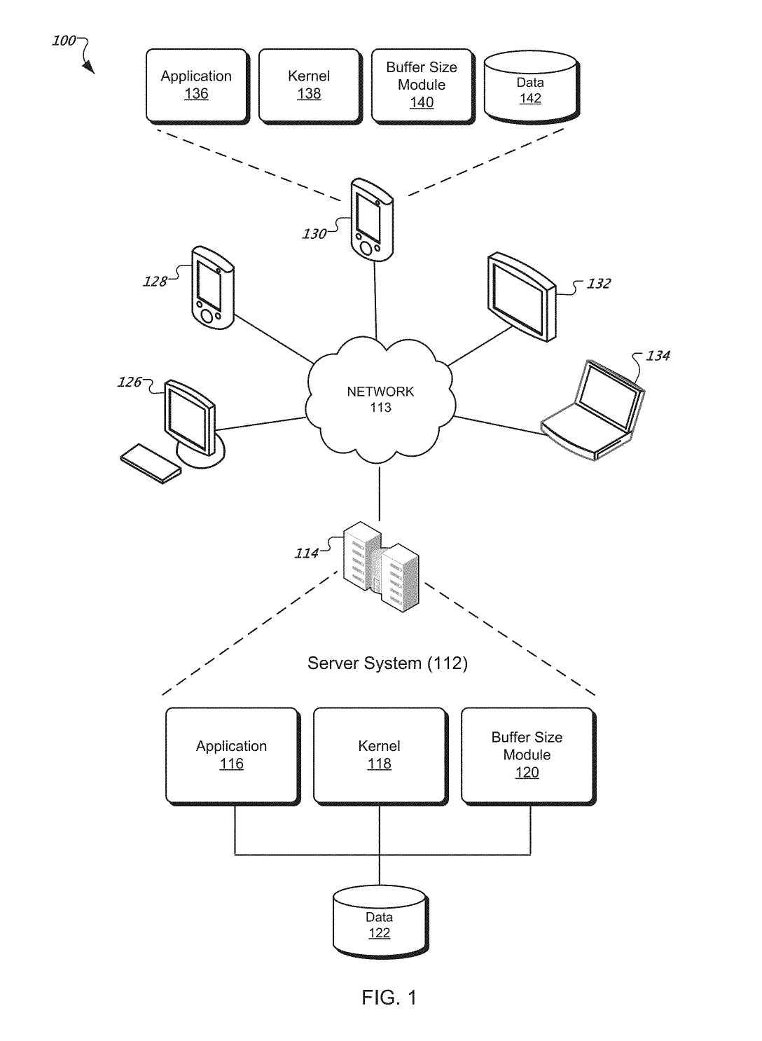

FIG. 1 illustrates an example system 100 for optimizing transmission buffer sizes for a plurality of network connections. A server system 112 provides processing, data storage, and data transmission. The server system 112 can include one or more processors 114, software components, and databases that can be deployed at various geographic locations or data centers. The server system 112 software components can include a server application 116, a server kernel 118, and a server buffer size module 120. The software components can include subcomponents that can execute on the same or on different individual data processing apparatus. The server system 112 databases can include server data 122, which can reside in one or more physical storage systems. The server data 122 can generally include, for example, information related to one or more of the following: the server system 112 itself, current or previous network connections for the server system 112, current or previous bandwidth requirements, software installed or otherwise used on the server system 112 or client devices, and user preferences. The software components and databases will be further described below. Although the server application 116, the server kernel 118, and the buffer size module 120 are depicted as being connected to or in communication with the databases (e.g., server data 122), the server application 116, the server kernel 118, and/or the buffer size module 20 are not necessarily connected to or in communication with the databases.

An application having a suitable graphical user interface can be provided as an end-user application to allow users to exchange information or otherwise interact with the server system 112. The end-user application can be accessed through a network 113 (e.g., the Internet and/or a local network) by users of client devices. In the depicted example, the client devices include user client devices 126, 128, 130, 132, and 134. Each client device may be, for example, a personal computer, a smart phone, a tablet computer, or a laptop computer. Other client devices are possible.

As shown with respect to client device 130, each client device may include one or more processors, software components, and/or databases. For example, the client device 130 software components can include a client application 136, a client kernel 138, and a client buffer size module 140. The software components can include subcomponents that can execute on the same or on different individual data processing apparatus. The client device 130 databases can include client data 142, which can reside in one or more physical storage systems. The client data 142 can generally include, for example, information related to one or more of the following: the client device 130 itself, current or previous network connections for the client device 130, current or previous bandwidth requirements, software installed or otherwise used on the client device 130, and user preferences. Client devices 126, 128, 132, and 134 preferably include similar client applications, client kernels, client buffer size modules, and/or client data.

In general, the server application 116 and the client application 136 can be software programs being run on the server system 112 and the client device 130, respectively. The server application 116 and the client application 136 can support one or more activities being performed on the server system 112 and the client device 130, respectively, and may interact with one another and/or exchange information. For example, a user of the client device 130 may use the client application 136 to perform an activity (e.g., play a game, request information, browse the Internet, watch a video, send a picture, send an email, etc.) and the client application 136 may periodically send information to and/or request information from the server application 116. In the specific case of a multi-player online game, for example, the user may play the game by interacting with the client application 136 on the client device 130. The client application 136 may send information regarding the user's game activities to the server application 116, which may process the user's activities and the activities of other game players. The server application 116 may send information regarding the game environment and activities of the players to the client application 136 and client applications of other users. Likewise, in the case of a user browsing the Internet, the client application 136 may be a web browser application and the server application 116 may be an application associated with a website. For example, when a user uses the client application 136 to access a search engine website, the server application 116 may be an application used to respond to search requests and installed on a server for the website. When a user submits a search query, the client application 136 may send the query to the server application 116, and the server application 116 may perform the search and send the search results to the client device 130.

In general, the server kernel 118 and the client kernel 138 can be portions of operating systems running on the server system 112 and the client device 130, respectively, that have control over the activities and processes occurring on the server system 112 and the client device 130. In various implementations, the two kernels respectively control the exchange of data between the server system 112 and the client device 130. Such exchanges may occur, for example, using Transmission Control Protocol/Internet Protocol (TCP/IP) or other data transfer protocols, including a connectionless protocol, such as User Datagram Protocol (UDP). Each kernel may include or utilize one or more memory buffers per connection for transferring data between the server system 112 and the client device 130. For example, the server kernel 118 may include a send buffer for sending data to the client device 130 and a receive buffer for receiving data from the client device 130. Likewise, the client kernel 138 may include or utilize a send buffer for sending data to the server system 112 and a receive buffer for receiving data from the server system 112. In various examples, send buffers and/or receive buffers are referred to herein as “transmission buffers.”

In certain implementations, the server buffer size module 120 and the client buffer size module 140 can be used to optimize a connection between the server system 112 and the client device 130. The server buffer size module 120 and/or the client buffer size module 140 may determine appropriate sizes for the buffers used to transfer data over the connection. Such buffer size determinations may be made by considering, for example, a desired bandwidth and a measured latency for the connection, as described herein.

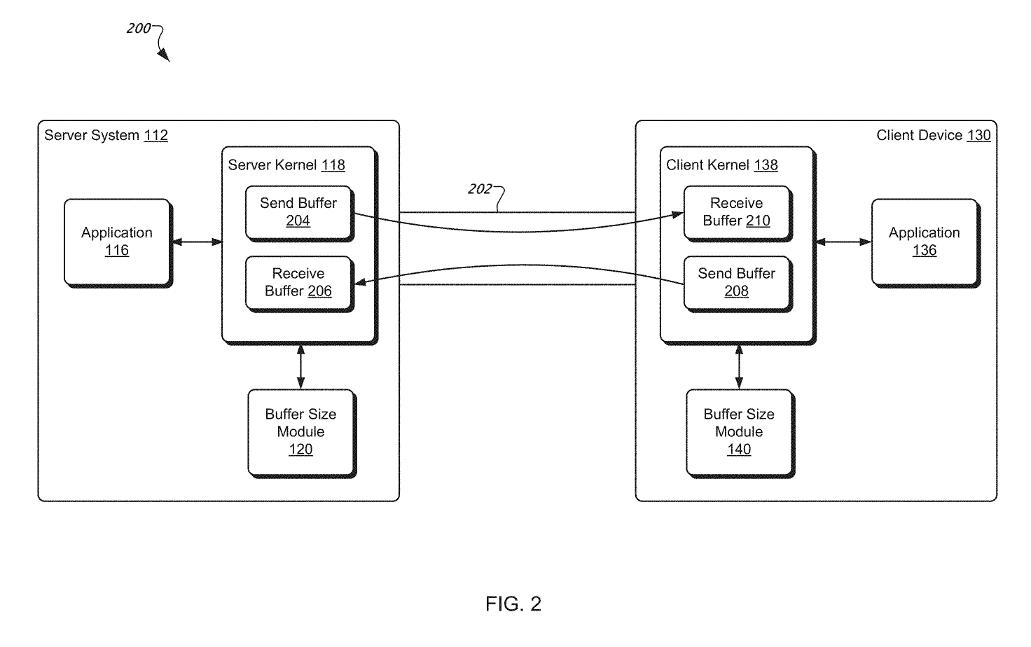

FIG. 2 is an example system 200 showing a connection 202 between the server system 112 and the client device 130. The connection 202 may be, for example, a TCP/IP connection, and may use or include the network 113. In the depicted example, the server kernel 118 can include or define a send buffer 204 and a receive buffer 206 for exchanging information with the client device 130 on a given connection. For example, the server system 112 or server kernel 118 may include or have access to a server memory, which may be a fixed, physical amount of memory, and the server kernel 118 can allocate desired sizes for the send buffer 204 and/or the receive buffer 206 from the server memory. The sizes for the send buffer 204 and/or the receive buffer 206 can be adjusted periodically by the server kernel 118 over time, as described herein. Likewise, the client kernel 138 can include or define a send buffer 208 and a receive buffer 210 for exchanging information with the server system 112 on a given connection. For example, the client device 130 or client kernel 138 may include or have access to a client memory, which may be a fixed, physical amount of memory, and the client kernel 138 can allocate desired sizes for the send buffer 208 and/or the receive buffer 210 from the client memory. The sizes for the send buffer 208 and/or the receive buffer 210 can be adjusted periodically by the client kernel 138 over time, as described herein.

In various examples, when transferring data from the server application 116 to the client application 136, the data can be copied to the send buffer 204. For example, the server application 116 can use a sockets application programming interface (API) to let the server kernel 118 know that there is data ready to be sent. The contents of the send buffer 204 can be sent to the receive buffer 210 over the connection 202, for example, when the data is placed in the send buffer 204, when the send buffer 204 is full, or after a specified amount of time has passed. The client application 136, using an API, may extract the data from the receive buffer 210, for example, when the data arrives in the receive buffer 210, when the receive buffer 210 is full, or after a specified amount of time has passed. Likewise, when transferring data from the client application 136 to the server application 116, the data is copied to the send buffer 208. The contents of the send buffer 208 can be sent to the receive buffer 206 over the connection 202, for example, when the data is placed in the send buffer 208, when the send buffer 208 is full, or after a specified amount of time has passed. The server application 116 may extract the data from the receive buffer 206, for example, when the data arrives in the receive buffer 206, when the receive buffer 206 is full, or after a specified amount of time has passed.

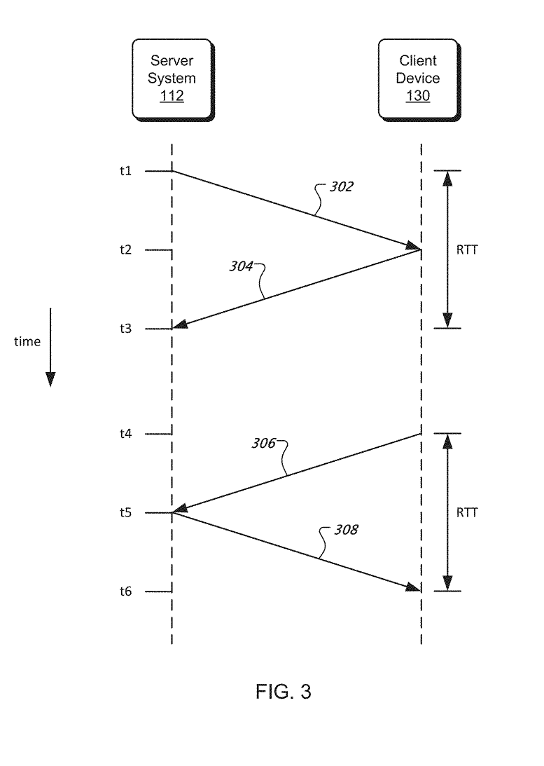

FIG. 3 is an example data flow diagram showing a flow of data over the connection 202 between the server system 112 and the client device 130. At time t1, the server system 112 sends data 302 to the client device 130. The data 302 arrives at the client device 130 at time t2. When the client device 130 receives the data 302, the client device 130 sends an acknowledgement 304 to the server system 112, informing the server system 112 that the data has been received. The acknowledgement 304 is received at the server system 112 at time t3. The time it takes for the server system 112 to send the data 302 to the client device 130 and receive the acknowledgement 304 back from the client device 130 (i.e., time t3−time t1) is referred to as a round-trip time (RTT) for the transfer of data 302 over the connection 202. At time t4, the client device 130 sends data 306 to the server system 112. When the server system 112 receives the data 306 at time t5, the server system 112 sends an acknowledgement 308 to the client device 130. The acknowledgement 308 is received by the client device 130 at time t6. The difference between time t6 and time t4 is an RTT for the transfer of data 306 over the connection 202.

In various examples, the systems and methods can record times at which data is sent and/or received over a connection and can use the recorded times to determine RTT. For example, when the server system 112 sends the data 302 to the client device 130, the server kernel 118 may add an initial timestamp (i.e., at time t1) to the data 302. When the client device 130 sends the acknowledgement 304, the client kernel 138 may forward the initial timestamp and may add an acknowledgement timestamp (i.e., at time t2). When the server system 112 receives the acknowledgement 304 at time t3, the server kernel 118 may determine RTT based on a difference between time t3 and the initial timestamp at time t1 (i.e., time t3−time t1). Alternatively or additionally, the server kernel 118 or the client kernel 138 may determine the time it took for the data 302 to be sent from the server system 112 to the client device 130 based on the difference between the initial timestamp at time t1 and the acknowledgement timestamp at time t2 (i.e., time t2−time t1). The server kernel 118 may determine a time it took for the acknowledgement 304 to be sent from the client device 130 to the server system 112 based on the difference between time t3 and the acknowledgement timestamp at time t2 (i.e., time t3−time t2). In this way, the server kernel 118 and/or the client kernel 138 can compute, record, and/or monitor RTTs associated with the connection 202.

In certain examples, the system and methods described herein can determine the bandwidth requirement associated with the connection 202 between the server system 112 and the client device 130. The bandwidth requirement may be determined based on system specifications (e.g., required refresh rates and/or required data transfer rates) and/or by monitoring data transfer rates to and from a client application installed on one or more client devices. The bandwidth requirement may be, for example, a rate of data transfer that the client application 136 requires to perform properly (e.g., a minimum rate of data transfer required for proper performance of the client application 136). In general, by determining and implementing the bandwidth requirement, the sizes of send and/or receive buffers on the server system 112 and/or one or more client devices may be reduced. This can greatly reduce memory pressure on the server system 112, particularly when the server system 112 is supporting many connections (e.g., thousands or millions of connections) with client devices. In other words, by minimizing memory usage for connections involving the server system 112, the server system 112 can handle more connections and/or can scale to thousands of connections or more. Smaller buffer sizes may also improve latency (e.g., RTT or RTT/2) for the connections, for example, because less time may be required to fill up a send buffer before data is sent.

In some examples, the bandwidth requirement differs according to the direction of data flow between the server system 112 and the client device 130. For example, a bandwidth requirement for data transfer from the server system 112 to the client device 130 may be different from a bandwidth requirement for data transfer from the client device 130 to the server system 112. When data is transferred primarily from the server system 112 to the client device 130, the bandwidth requirement may be higher for that direction. Such a situation may arise, for example, when the client device 130 is streaming video from the server system 112. The opposite situation may arise, for example, when the client device 130 is streaming video to the server system 112. In that case, the bandwidth requirement may be higher for data transfers from the client device 130 to the server system 112, than for data transfers from the server system 112 to the client device 130.

In certain instances, the systems and methods can determine or obtain bandwidth requirements for all connections associated with a client device. For example, when a particular client device has more than one connection to a server or multiple servers, the bandwidth requirements for the connections may be combined to determine an aggregated bandwidth for that client device. The aggregated bandwidth requirement may be used to determine buffer sizes for one or more connections associated with the particular client device, in accordance with the techniques described herein.

In some examples, the bandwidth requirement(s) for a connection is/are determined by or communicated to the server system 112 and/or the client device 130. For example, bandwidth requirements may be communicated from the server system 112 to the client device 130 and/or from the client device 130 to the server system 112. In some instances, a provider of the server application 116 and/or the client application 136 determines the bandwidth requirement and provides the bandwidth requirement to the server system 112, which may then communicate the bandwidth requirement to the client device 130.

In various examples, the server buffer size module 120 can be used to determine appropriate sizes for the send buffer 204 and/or the receive buffer 206. The server buffer size module 120 may determine sizes for the send buffer 204 and/or the receive buffer 206 based on, for example, a bandwidth requirement and/or the RTT. The server buffer size module 120 may extract the RTT from the server kernel 118 and/or may monitor the RTT over time. In various instances, the size of the send buffer 204 and/or the receive buffer 206 may be determined as follows:

Buffer Size=RTT×Bandwidth Requirement,

where RTT is the round-trip time for the connection 202. When determining the size of the send buffer 204, the Bandwidth Requirement in this equation is preferably the bandwidth requirement for data transfer from the server system 112 to the client device 130. When determining the size of the receive buffer 206, the Bandwidth Requirement in this equation is preferably the bandwidth requirement for data transfer from the client device 130 to the server system 112.

Likewise, the client buffer size module 140 may be used to determine appropriate sizes for the send buffer 208 and/or the receive buffer 210. The client buffer size module 140 may determine sizes for the send buffer 208 and/or the receive buffer 210 based on, for example, a bandwidth requirement and/or the RTT. The client buffer size module 140 may extract the RTT from the client kernel 138 and/or may monitor the RTT over time. In various instances, the size of the send buffer 208 and/or the receive buffer 210 may be determined as follows:

Buffer Size=RTT×Bandwidth Requirement,

where RTT is the round-trip time for the connection 202. When determining the size of the send buffer 208, the Bandwidth Requirement in this equation is preferably the bandwidth requirement for data transfer from the client device 130 to the server system 112. When determining the size of the receive buffer 210, the Bandwidth Requirement in this equation is preferably the bandwidth requirement for data transfer from the server system 112 to the client device 130.

Buffer sizes may be determined when a connection is first established and may be adjusted periodically, if desired, during the life of the connection. For example, when the connection 202 between the server system 112 and the client device 130 is first established, the sizes of the send and receive buffers may be set to initial or default values. After initial communications have begun and the RTT is measured for the connection 202, buffer sizes may be calculated using the methods described herein. To ensure buffer sizes remain at the desired values, RTT may be extracted from the server kernel 118 and/or the client kernel 138 periodically and buffers may be resized accordingly (e.g., every minute, every two minutes, or every 10 minutes). Such periodic resizing can help compensate for any changes that occur to the connection 202 over time and maintain optimum memory usage on the server system 112.

Once desired transmission buffer sizes are determined, the server buffer size module 120 and/or the client buffer size module 140 may implement any desired changes. For example, the server buffer size module 120 and/or the client buffer size module 140 may send the desired transmission buffer sizes to the respective kernels 118 and 138, and the kernels 118 and 138 may implement the desired changes. Alternatively or additionally, kernels 118 and 138 may communicate with one or more network drivers for the connection (e.g., TCP/IP network drivers) and instruct the network driver(s) to change the buffer sizes.

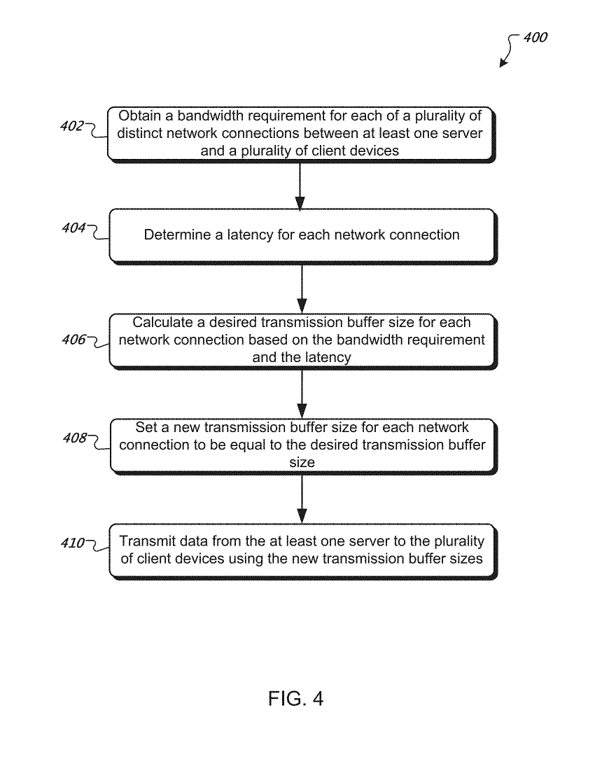

FIG. 4 is a flowchart of an example method 400 for sizing transmission buffers for a plurality of connections. The transmission buffers can be or include, for example, send buffers and/or receive buffers, and the transmission buffers can reside on or be used by servers and/or client devices. The method includes obtaining (step 402) a respective bandwidth requirement for each of a plurality of distinct network connections between at least one server and a plurality of client devices. A respective latency (e.g., RTT or RTT/2) is determined (step 404) for each network connection. A desired size for at least one transmission buffer is determined (step 406) for each network connection, based on the respective bandwidth requirement and the respective latency for the network connection. A new transmission buffer size is set (step 408) for each network connection to be equal to the desired transmission buffer size for the network connection. To set a new a transmission buffer size on a server, for example, a kernel on the server can allocate or adjust a size of a send buffer and/or a receive buffer on the server. Likewise, to set a new a transmission buffer size on a client, a kernel on the client can allocate or adjust a size of a send buffer and/or a receive buffer on the client. Data is transmitted (step 410) from the at least one server to the plurality of client devices using the new transmission buffer sizes.

In various examples, the systems and methods described herein reduce latency by identifying and implementing a minimum transmission buffer size. In general, when an application on a server is sending data to a client device, the data resides in the send buffer for a time equal to the send buffer size divided by bandwidth. By minimizing the send buffer size, the data spends less time in the send buffer before it is sent to the client device, thereby reducing latency. Minimizing transmission buffer sizes also reduces storage requirements, which can be difficult to satisfy when the number of server-client connections is in the thousands or millions.

In some implementations, the systems and methods described herein are used to size transmission buffers on only the server system 112 or the client device 130. For example, when the flow of data is primarily from the server system 112 to the client device 130, it may not be necessary or desirable to adjust transmission buffer sizes on the client device 130. In that case, the systems and methods may be used to size the transmission buffers only on the server system 112. On the other hand, when the flow of data is primarily from the client device 130 to the server system 112, it may not be necessary or desirable to adjust transmission buffer sizes on the server system 112, and the systems and methods may be used to size the transmission buffers only on the client device 130. When the flow of data in both directions is similar (e.g., within a factor of 10), the systems and methods may be used to adjust transmission buffer sizes on both the client device 130 and the server system 112.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. For example, parallel processing may be used to perform multiple language detection methods simultaneously. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method, comprising:
obtaining a respective bandwidth requirement for each of a plurality of network connections between at least one server and at least one client device;
determining a respective latency for each network connection;
calculating, by one or more computer processors, a desired transmission buffer size for each network connection based on the respective bandwidth requirement and the respective latency for the network connection;
setting a new transmission buffer size for each network connection to the desired transmission buffer size for the network connection; and
transmitting data from the at least one server to the at least one client device using the new transmission buffer size.

2. The method of claim 1, wherein obtaining the respective bandwidth requirement for each of the plurality of network connections comprises:
determining a target data transfer rate for an application running on a client device associated with one of the network connections.

3. The method of claim 1, wherein obtaining the respective bandwidth requirement for each of the plurality of network connections comprises:
measuring an amount of data transmitted over at least one network connection during a time period.

4. The method of claim 1, wherein determining the respective latency for each network connection comprises:
determining a round-trip time for at least one network connection.

5. The method of claim 4, wherein the respective latency for the at least one network connection comprises the round-trip time divided by two.

6. The method of claim 4, wherein determining the round-trip time comprises:
obtaining the round-trip time from the at least one server.

7. The method of claim 1, wherein calculating the desired transmission buffer size for each network connection comprises:
determining a product of the respective bandwidth requirement and the respective latency for at least one network connection.

8. The method of claim 1, wherein at least one network connection comprises a transport control protocol/internet protocol (TCP/IP) connection.

9. The method of claim 1, wherein at least one network connection is connectionless.

10. The method of claim 1, further comprising:
determining a respective latency for at least one network connection at a later time; and
calculating a new desired transmission buffer size for the at least one network connection based on the respective latency at the later time.

11. A system, comprising:
one or more computer processors to
obtain a respective bandwidth requirement for each of a plurality of network connections between at least one server and at least one client device;
determine a respective latency for each network connection;
calculate a desired transmission buffer size for each network connection based on the respective bandwidth requirement and the respective latency for the network connection;
set a new transmission buffer size for each network connection to the desired transmission buffer size for the network connection; and
transmit data from the at least one server to the at least one client device using the new transmission buffer size.

12. The system of claim 11, wherein to obtain the respective bandwidth requirement for each of the plurality of network connections, the one or more computer processors are to:
determine a target data transfer rate for an application miming on a client device associated with one of the network connections.

13. The system of claim 11, wherein to obtain the respective bandwidth requirement for each of the plurality of network connections, the one or more computer processors are to:
measure an amount of data transmitted over at least one network connection during a time period.

14. The system of claim 11, wherein to determine the respective latency for each network connection, the one or more computer processors are to:
determine a round-trip time for at least one network connection.

15. The system of claim 14, wherein the respective latency for the at least one network connection comprises the round-trip time divided by two.

16. The system of claim 14, wherein to determine the round-trip time, the one or more computer processors are further to:
obtain the round-trip time from the at least one server.

17. The system of claim 11, wherein to calculate the desired transmission buffer size for each network connection, the one or more computer processors are further to:
determine a product of the respective bandwidth requirement and the respective latency for at least one network connection.

18. The system of claim 11, wherein at least one network connection comprises a transport control protocol/internet protocol (TCP/IP) connection.

19. The system of claim 11, wherein the one or more computer processors are further to:
determine a respective latency for at least one network connection at a later time; and
calculate a new desired transmission buffer size for the at least one network connection based on the respective latency at the later time.

20. A non-transitory computer-readable medium having instruction stored thereon that, when executed by one or more computer processors, cause the one or more computer processors to:
obtain a respective bandwidth requirement for each of a plurality of network connections between at least one server and at least one client device;
determine a respective latency for each network connection;
calculate a desired transmission buffer size for each network connection based on the respective bandwidth requirement and the respective latency for the network connection;
set a new transmission buffer size for each network connection to the desired transmission buffer size for the network connection; and
transmit data from the at least one server to the at least one client device using the new transmission buffer size.
